(19) United States
(12) Patent Application Publication
(10) Pub. No.: US 2019/0362127 A1
(43) Pub. Date: Nov. 28, 2019

(54) FINGERPRINT ENROLLMENT METHOD AND ELECTRONIC DEVICE USING THE SAME

(71) Applicant: ELAN MICROELECTRONICS CORPORATION, Hsinchu (TW)

(72) Inventors: Chun Chien, Hsinchu City (TW); Li-Wei Lin, Yilan City (TW); Yen-Cheng Lin, Taipei City (TW)

(73) Assignee: ELAN MICROELECTRONICS CORPORATION, Hsinchu (TW)

(21) Appl. No.: 16/248,747

(22) Filed: Jan. 15, 2019

Related U.S. Application Data
(60) Provisional application No. 62/674,631, filed on May 22, 2018.

(30) Foreign Application Priority Data
Sep. 3, 2018 (TW) 107130882

(51) Int. Cl. G06K 9/00

(52) U.S. Cl. CPC G06K 9/00067; G06K 9/0004

(57) ABSTRACT

A fingerprint enrollment method is provided. The method provides an instruction to prompt a user to move a finger on the fingerprint sensor in a spiral path for fingerprint enrollment. While the finger moves on the fingerprint sensor, the fingerprint sensor scans the finger and obtains multiple fingerprint images. According to the fingerprint enrollment method of the invention, the enrollment time is effectively reduced and un-deformed fingerprint images are easily obtained.

### CROSS-REFERENCE TO RELATED APPLICATIONS

This application claims the benefit of United States provisional application filed on May 22, 2018 and having application Ser. No. 62/674,631, the entire contents of which are hereby incorporated herein by reference.

This application is based upon and claims priority under 35 U.S.C. 119 from Taiwan Patent Application No. 107130882 filed on Sep. 3, 2018, which is hereby specifically incorporated herein by this reference thereto.

### BACKGROUND OF THE INVENTION

### 1. Field of the Invention

The present invention relates to biometrics enrollment, and in particular to a method of enrolling fingerprints.

### 2. Description of the Prior Arts

Fingerprint recognition is commonly used in electronic devices recently. As a user identification technology, a user must pre-enroll fingerprint of at least one finger in an electronic device. When identity recognition is required (such as unlocking an electronic device, opening a particular application program, using a particular function, etc.), the electronic device senses the user's fingerprint and compares it with a pre-enrolled fingerprint to identify the user.

In general, fingerprint sensors are smaller than fingers. A conventional fingerprint enrollment method requires the user to press the fingerprint sensor multiple times with different parts of the finger. With reference to FIG. 13, during the multiple presses, the fingerprint sensor obtains a plurality of fingerprint images 60 of the finger as fingerprint enrollment data. The conventional method has drawbacks. The user does not actually confirm whether he has pressed each part of the finger over the fingerprint sensor. Therefore, the plurality of fingerprint images 60 obtained by the fingerprint sensor are still generally not complete enough, and the user is required to press the sensor more times. The conventional method is inconvenient for the user and will increase the enrollment time.

Another conventional fingerprint enrollment method is so-called as swiping enrollment method. As shown in FIG. 14, the user needs to swipe the finger on the fingerprint sensor for multiple times in different directions, so that the fingerprint images 70 of different parts of the finger are obtained by the fingerprint sensor and are taken as the fingerprint enrollment data. The conventional method also has drawbacks. As shown in FIG. 15, the arrow in the FIG. 15 represents the direction in which the finger swipe over the fingerprint sensor. When the finger swipes on the fingerprint sensor and then leaves the fingerprint sensor, the force of the finger contact changes. Also, the moving speed of the finger is usually getting faster and faster, so that the fingerprint sensor easily captures the deformed fingerprint image as the fingerprint images 71, 72.

### SUMMARY OF THE INVENTION

To overcome the shortcomings, the present invention provides a fingerprint enrollment method to solve the problems of the conventional method, such as that the enrollment time is too long, the obtained fingerprint image is not complete, and deformed fingerprint image is easily obtained, and so on.

To achieve aforementioned objective, the present invention provides a fingerprint enrollment method comprising steps of:

(a) providing an instruction, wherein the instruction is used to prompt a user to move a finger on a fingerprint sensor in a spiral path;

(b) obtaining multiple fingerprint images by the fingerprint sensor while the finger moves on the fingerprint sensor.

In another aspect, the present invention provides an electronic device comprising:

a fingerprint sensor; and

a display showing an instruction when the electronic device proceeds a fingerprint enrollment, wherein

the instruction is used to prompt a user to move a finger on the fingerprint sensor in a spiral path so that the fingerprint sensor obtains multiple fingerprint images.

The advantage of the present invention is that an instruction is provided to prompt the user to perform fingerprint enrollment with a spiral path. With the finger moves in a spiral path, the fingerprint sensor collects multiple fingerprint images in a short time. No only the enrollment time is effectively shortened, but also the deformed fingerprint image is less likely to be obtained.

### BRIEF DESCRIPTION OF THE DRAWINGS

FIG. 1A is a flowchart of a first embodiment of a fingerprint enrollment method in accordance with the present invention;

FIG. 1B is a flowchart of a second embodiment of a fingerprint enrollment method in accordance with the present invention;

FIG. 2 is an operational view of the fingerprint enrollment method in accordance with the present invention, showing that the user moves the finger according to the instruction;

FIG. 3 is an illustrative view of the fingerprint images that obtained through the fingerprint enrollment method in accordance with the present invention;

FIG. 4 is an illustrative view of a first embodiment of an instruction in accordance with the present invention;

FIG. 5 is an illustrative view of a second embodiment of an instruction in accordance with the present invention;

FIG. 6 is an illustrative view of a third embodiment of an instruction in accordance with the present invention;

FIG. 7 is an illustrative view of a fourth embodiment of an instruction in accordance with the present invention;

FIG. 8 is an illustrative view of a fifth embodiment of an instruction in accordance with the present invention;

FIGS. 9A to 9C are operational illustrative views of a first embodiment of a process for displaying an instruction in accordance with the present invention;

FIGS. 10A to 10C are operational illustrative views of a second embodiment of a process for displaying an instruction in accordance with the present invention;

FIG. 11 is an illustrative view of a complete fingerprint image that stitched by the fingerprint images obtained through the fingerprint enrollment method in accordance with the present invention;

FIG. 12 is a block diagram of an electronic device in accordance with the present invention;

FIG. 13 is an illustrative view of the fingerprint images that obtained through a conventional pressing method in accordance with the prior art;

FIG. 14 is an illustrative view of the fingerprint images that obtained through a conventional swiping method in accordance with the prior art; and

FIG. 15 is an illustrative view of the deformed fingerprint images that obtained through the conventional swiping method in accordance with the prior art.

### DETAILED DESCRIPTION OF THE EMBODIMENTS

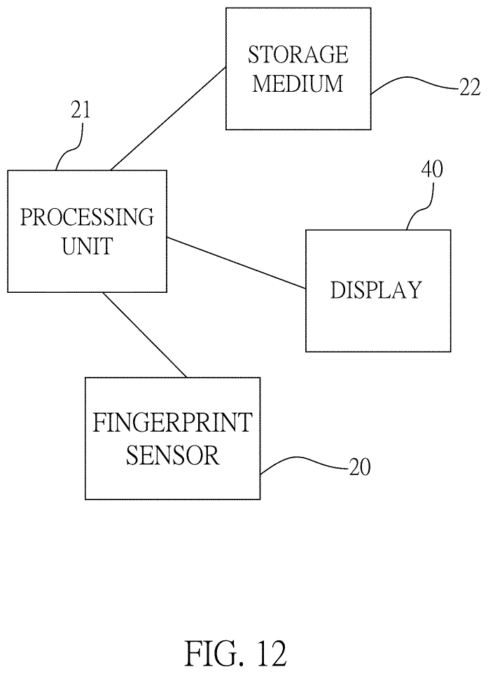

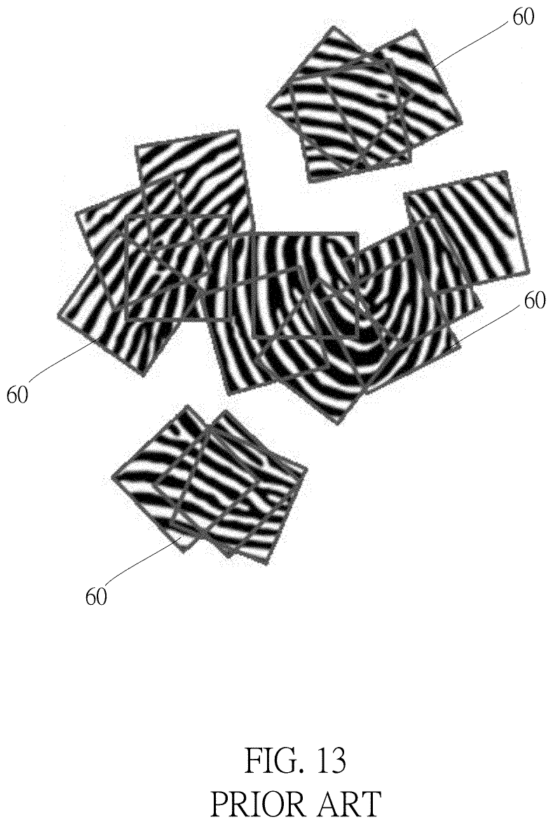

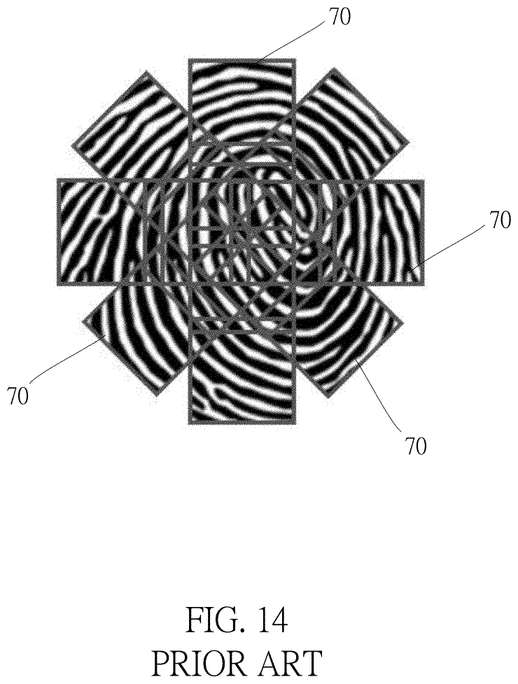

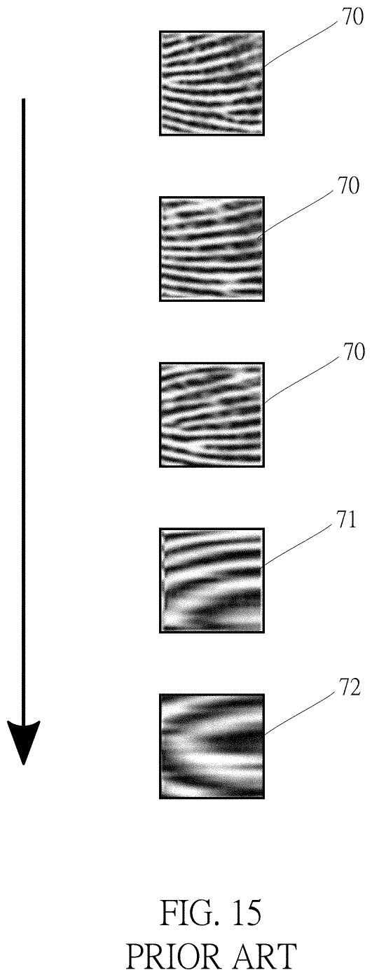

With reference to FIG. 12, an embodiment of an electronic device in accordance with the present invention comprises a fingerprint sensor 20, a display 40, a processing unit 21 and a storage medium 22. The processing unit 21 is coupled to the fingerprint sensor 20, the display 40, and the storage medium 22. The fingerprint sensor 20 is used to sense a fingerprint of a finger. A size of the fingerprint sensor 20 is smaller than that of the finger. For example, the size of the present fingerprint sensor 20 is 6 mm*6 mm to 12 mm*12 mm, and the size of the finger is about 20 mm*20 mm. The fingerprint sensor 20 may be optical fingerprint sensor or capacitive fingerprint sensor, and both can be adapted for the present invention.

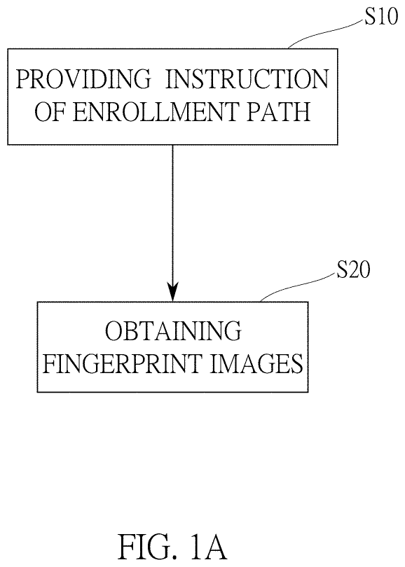

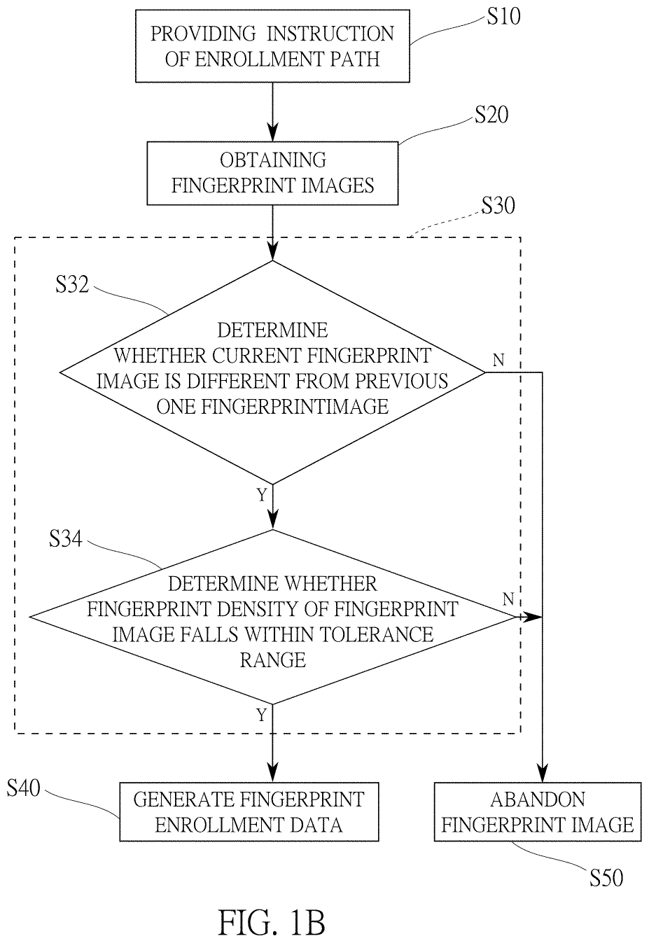

With reference to FIG. 1A, a fingerprint enrollment method in accordance with the present invention comprises steps of:

Providing an instruction of an enrollment path (S10): The processing unit 21 provides the instruction. The instruction is used to prompt the user to move a finger on the fingerprint sensor 20 in a spiral path. In one embodiment, the instruction is a visually visible instruction. When a fingerprint enrollment is performed on the electronic device, the processing unit 21 provides the instruction to the display 40, and the display 40 shows the instruction. The following shows various ways to show the instruction, but are not limited thereto. In another embodiment, the instruction may also be an audio instruction.

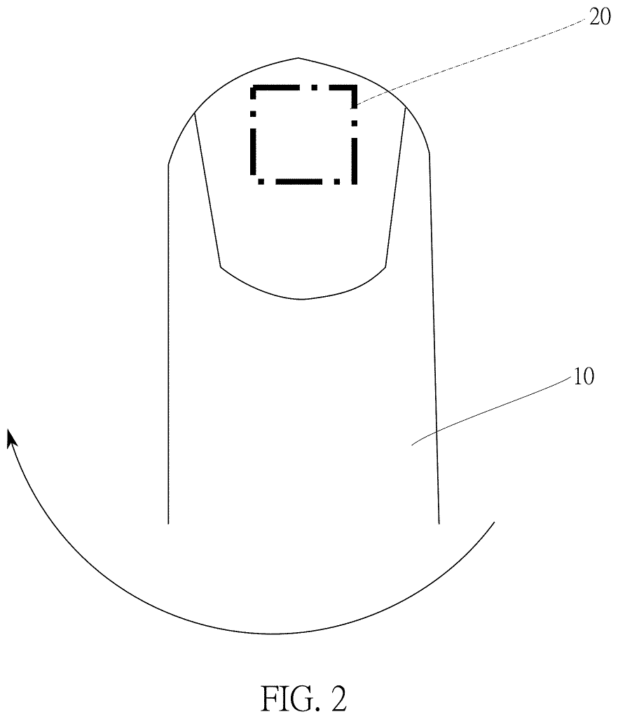

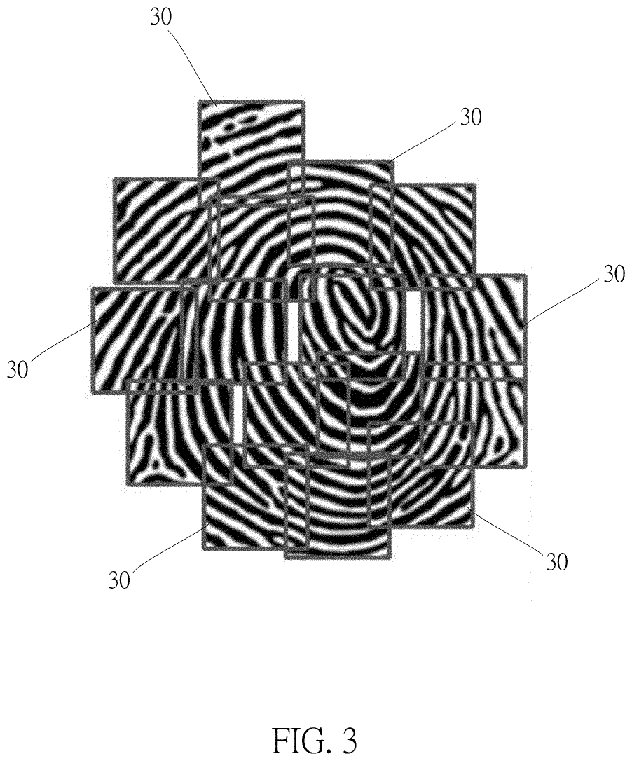

Obtaining the fingerprint images (S20): With further reference to FIGS. 2 and 3, the fingerprint sensor 20 senses the finger when the finger touches on the fingerprint sensor 20 to obtain a fingerprint image 30. Since the size of the fingerprint sensor 20 is smaller than that of the finger 10, the fingerprint image 30 is a partial image of a complete fingerprint of the finger 10. When the finger 10 moves on the fingerprint sensor 20, the fingerprint sensor 20 senses the finger 10 for multiple times to obtain multiple fingerprint images 30.

The fingerprint sensor 20 transmits the obtained multiple fingerprint images 30 to the processing unit 21. The processing unit 21 generates one or multiple fingerprint enrollment data according to the multiple fingerprint images 30.

In one embodiment, the method in accordance with the present invention further comprises multiple steps S30 to S50 as shown in FIG. 1B. The program codes corresponding to the steps S30, S40 and S50 are stored in the storage medium 22. The processing unit 22 executes the codes in the storage medium 22 to implement the steps S30, S40 and S50.

The step S30 is used to determine whether the fingerprint image 30 obtained in the step S20 is qualified. When the fingerprint image 30 is determined to be qualified, the step S40 is proceeded to generate a fingerprint enrollment datum according to the qualified fingerprint image 30. When the fingerprint image 30 is determined to be unqualified, the step S50 is proceeded to abandon the unqualified fingerprint image 30.

During the fingerprint enrollment, the steps S20 to S50 are repeated multiple times to obtain multiple qualified fingerprint images 30. In one embodiment, the processing unit 21 further counts the number of the qualified fingerprint images 30. When the number of qualified fingerprint images 30 reaches a predetermined value (such as 20), the processing unit 21 notifies the fingerprint sensor 20 to stop sensing the finger 10.

The processing unit 21 generates multiple fingerprint enrollment data and stores the multiple fingerprint enrollment data. When the user needs to identify the identity later, the multiple fingerprint enrollment data are used to perform fingerprint comparison to identify the user's identity. Algorithms and related details for generating enrollment data from fingerprint images are well known to those skilled in the art of fingerprint recognition and therefore are omitted for purposes of brevity. In another embodiment, the processing unit 21 stitches the multiple qualified fingerprint images 30 into a complete fingerprint image 31 as shown in FIG. 11, and generates an enrollment datum according to the complete fingerprint image 31. The details of stitching multiple fingerprint images into a complete fingerprint image are well known to those skilled in the art of fingerprint recognition and therefore are omitted for purposes of brevity.

In the embodiment as shown in FIG. 1B, the step S30 includes a step S32 and a step S34. The step S32 is to determine whether the current fingerprint image 30 is different from a previous fingerprint images 30 obtained before the current fingerprint image 30. One embodiment of the step S32 includes a calculation of subtracting a fingerprint image 30 from its previous fingerprint image 30. For example, the size of the fingerprint image is 80*80 pixels. The method to determine whether the N^{th} fingerprint image is different from the previous(N-1^{th}) fingerprint image comprises converting the two fingerprint images into grayscale and the pixel value of each pixel is represent by a value such as 0 to 256. Next, 6400 (80*80) difference values are obtained by subtracting the pixel values of one fingerprint image from the pixel values of another fingerprint image, and a sum of the 6400 difference values is calculated. The sum of the difference values is compared with a sum threshold. When the sum of the difference values is larger than the sum threshold, it is determined that the two fingerprint images are different. In another embodiment, the sum of the 6400 difference values is divided by 6400 to have a difference average. The difference average is compared with an average threshold. When the difference average is larger than the average threshold, it is determined that the two fingerprint images are different.

If the determination result in the step S32 is YES, the step S34 is further proceeded. If the determination result in the step S32 is NO, the step S50 is further proceeded to abandon the fingerprint image 30. During the fingerprint enrollment for the finger 10, it is desire to obtain fingerprints of all areas of the finger 10. With the step S32, it is able to avoid storing multiple identical fingerprint images. If the current fingerprint image 30 is different from the previous fingerprint image 30 obtained before the current fingerprint image 30, it means that the two fingerprint images 30 correspond to different regions on the finger 10.

The step S34 is to determine whether the fingerprint density D of the current fingerprint image 30 falls within a tolerance range. There are many ways to calculate the fingerprint density D. In some embodiments, the number of ridges, the number of valleys, or the number of alternating between peaks and valleys covered by the two diagonal lines (or more straight lines) of the fingerprint image 30 is used as the fingerprint density D. The tolerance range of the fingerprint density D may be determined by the fingerprint density D1 of the first fingerprint image 30 that is obtained by the fingerprint sensor 20 when sensing the finger 10. For example, the fingerprint density D1 is 10, then the tolerance range may be a predetermined range of 10 (such as plus or minus 30%), i.e. 7 to 13. Generally, the rapid movement of the finger 10 on the fingerprint sensor 20 easily leads to a deformed fingerprint image that cannot be used to generate fingerprint enrollment data. Since the fingerprint density of the deformed fingerprint image is relatively low, the deformed fingerprint image can be excluded by determining whether the fingerprint density of the fingerprint image 30 falls within the tolerance range.

When the determination result in the step S34 is YES, it means that the fingerprint image 30 is qualified. Then the step S40 is further proceeded.

According to the step S30 as shown in FIG. 1B, the step to determine whether the fingerprint image 30 is qualified includes that determining whether the current fingerprint image 30 is different from the previous fingerprint image obtained before the current fingerprint image 30, and that determining whether the fingerprint density D of the fingerprint image 30 falls within a tolerance range. However, the step S30 as shown in FIG. 1B is only one of the embodiments and is not intended to limit the present invention. In other embodiments, the sequence of the step S32 and S34 may be reversed. Alternatively, the step S30 may add more determination steps. Alternatively, the step S30 may reduce the determination step. For example, the step S30 may include only one of the steps S32 and S34.

According to the method of the present invention, the finger 10 is moved on the fingerprint sensor 20 in a spiral path instead of leaving and touching the fingerprint sensor 20 for many times. Therefore, the fingerprint sensor 20 can obtain multiple fingerprint images 30 in a short time so that the enrollment time is effectively shorten. When the finger 10 moves in a spiral path, the force of the finger pressing is generally consistent and the finger does not move too fast, such that less deformed fingerprint images are captured. Thus, the fingerprint images 30 obtained through the method in accordance with the present invention is more advantageous for subsequent fingerprint comparison. With the finger 10 moving on the fingerprint sensor 20 in a spiral path, it is easier to have all the fingerprints of the finger 10 to pass through the fingerprint sensor 20. Therefore, with the method in accordance with the present invention, it is easier to obtain a full fingerprint image.

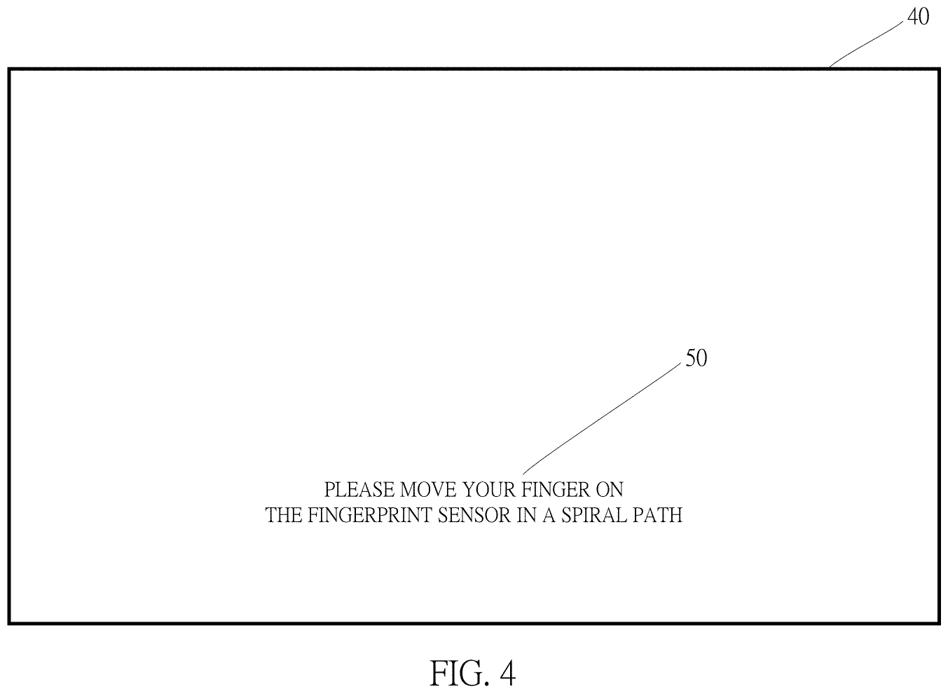

With reference to FIG. 4, in one embodiment, the instruction is a string of text 50 and is shown on the display 40. The content of the string of text 50 may be “Please move your finger on the fingerprint sensor in a spiral path.”

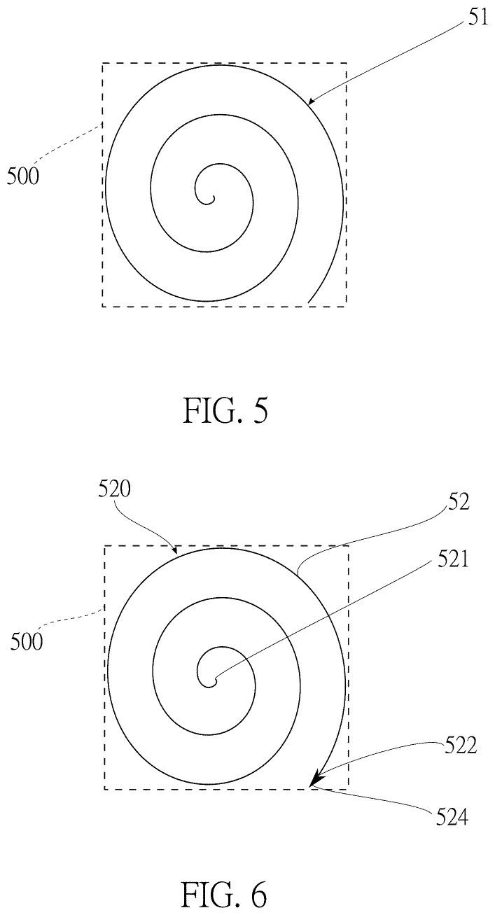

With reference to FIG. 5, in one embodiment, the instruction is a spiral curve 51 shown on the display 40 to prompt the user to move a finger according to the spiral curve 51. In one embodiment, the display 40 may also show an illustrative position 500 of the fingerprint sensor.

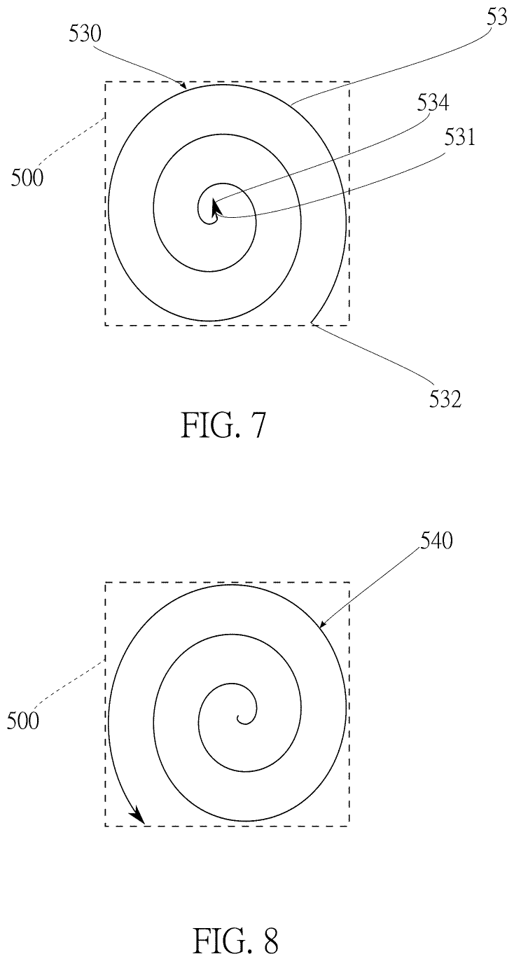

In another embodiment, the instruction comprises a spiral curve and a direction symbol for indicating that the direction of the spiral curve is from an inside to an outside of the spiral curve or from the outside to the inside of the spiral curve, so as to prompt the user to move the finger along with the direction. For example, the instruction 520 as shown in FIG. 6 comprises a spiral curve 52 and a direction symbol 524. The direction symbol 524 is an arrow and is located at an end of the spiral curve 52. The direction symbol 524 is used to show that an inner end 521 of the spiral curve 52 is a starting point and an outer end 522 of the spiral curve 52 is an end point. Alternatively, for example, the instruction 530 as shown in FIG. 7 comprises a spiral curve 53 and a direction symbol 534. The direction symbol 534 is used to show that an outer end 532 of the spiral curve 53 is a starting point and an inner end 531 of the spiral curve 53 is an end point.

In FIG. 6, the direction of the instruction 520 is clockwise. In the embodiment as shown in FIG. 8, the direction of the instruction 540 is counterclockwise.

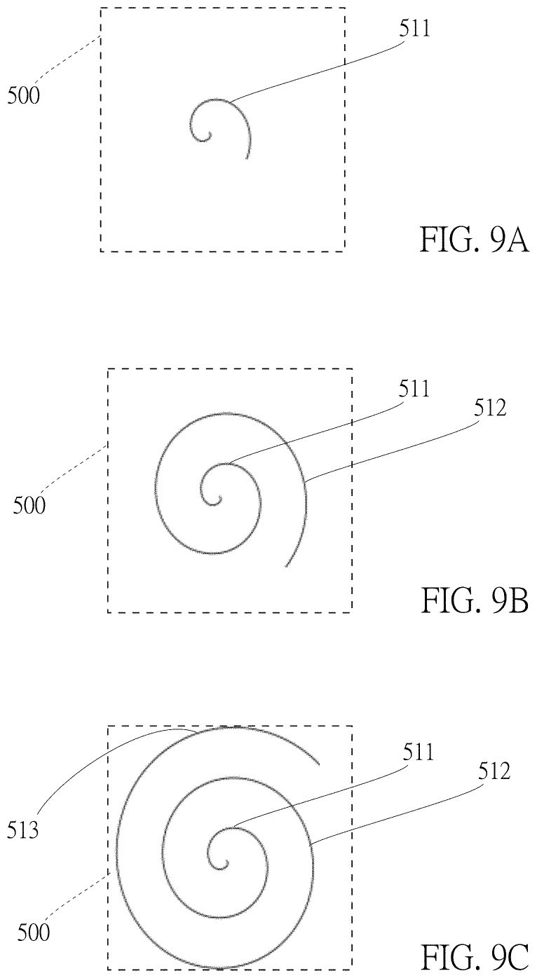

In another embodiment, the instruction is an animation. Using the spiral curve 51 as shown in FIG. 5 as an example, the way to show the instruction on the display 40 is to show the spiral curve 51 from the inside to the outside of the spiral curve 51 or from the outside to the inside of the spiral curve 51. With reference to FIGS. 9A to 9C, during showing the spiral curve 51, the spiral curve 51 is shown from the inside to the outside of the spiral curve 51. For example, firstly a first segment 511 is shown as presented in FIG. 9A, and then the first segment 511 and a second segment 512 are shown as presented in FIG. 9B. Then the first segment 511, the second segment 512 and a third segment 513 are shown as presented in FIG. 9C. At last the complete spiral curve 51 is shown as presented in FIG. 5.

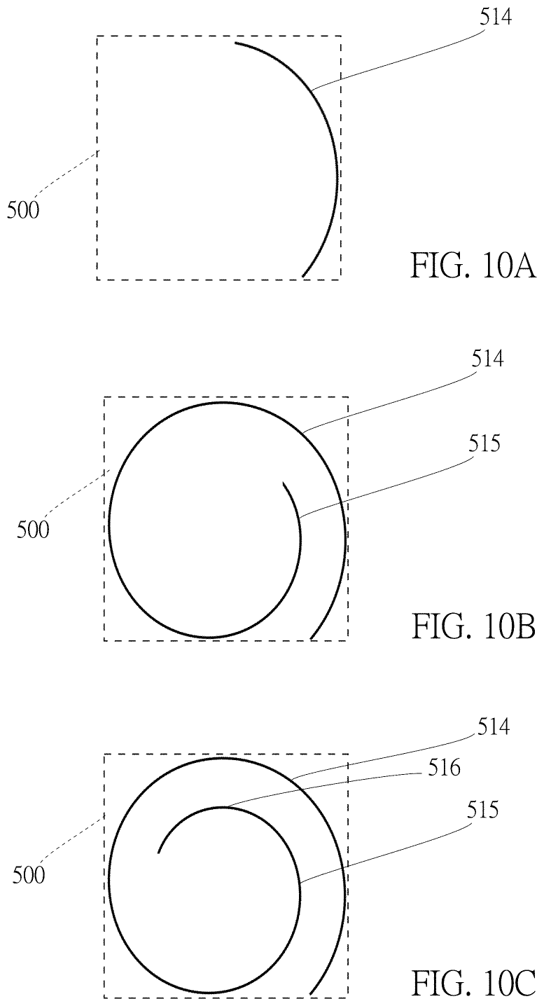

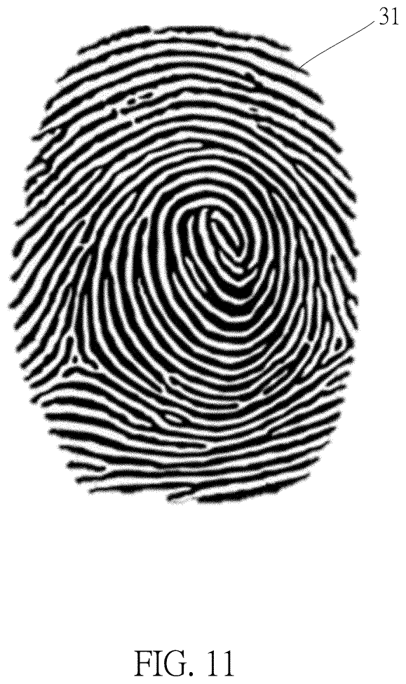

Another embodiment is shown in FIG. 10A to 10C and FIG. 5. During showing the spiral curve 51, the spiral curve 51 is shown from the outside to the inside of the spiral curve 51. For example, firstly a fourth segment 514 is shown as presented in FIG. 10A, and then the fourth segment 514 and a fifth segment 515 are shown as presented in FIG. 10B. Then the fourth segment 514, the fifth segment 515 and a sixth segment 513 are shown as presented in FIG. 10C. At last the complete spiral curve 51 is shown as presented in FIG. 5.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art.

What is claimed is:

1. A fingerprint enrollment method comprising steps of:
(a) providing an instruction, wherein the instruction is used to prompt a user to move a finger on a fingerprint sensor in a spiral path; and
(b) obtaining multiple fingerprint images by the fingerprint sensor while the finger moves on the fingerprint sensor.

2. The fingerprint enrollment method as claimed in claim 1, wherein the instruction comprises a spiral curve.

3. The fingerprint enrollment method as claimed in claim 2, wherein the instruction further comprises a direction symbol for indicating that a direction of the spiral curve is from an inside to an outside of the spiral curve or from the outside to the inside of the spiral curve to prompt the user to move the finger along with the direction.

4. The fingerprint enrollment method as claimed in claim 2, wherein a way to display the instruction is to display the spiral curve from an inside to an outside of the spiral curve or from the outside to the inside of the spiral curve.

5. The fingerprint enrollment method as claimed in claim 1, wherein the instruction comprises a text.

6. The fingerprint enrollment method as claimed in claim 1 further comprising a step of:
(c) determining whether each of the fingerprint images is qualified.

7. The fingerprint enrollment method as claimed in claim 6, wherein in the step c comprises a step of:
determining whether a current fingerprint image is different from a previous fingerprint image obtained before the current fingerprint image.

8. The fingerprint enrollment method as claimed in claim 6, wherein in the step c comprises a step of:
determining whether a fingerprint density of a current fingerprint image falls within a tolerance range.

9. The fingerprint enrollment method as claimed in claim 6, wherein the method further comprises stitching the qualified fingerprint images into a complete fingerprint image when multiple qualified fingerprint images are obtained by executing the step c.

10. The fingerprint enrollment method as claimed in claim 1, wherein the instruction is shown on a display.

11. The fingerprint enrollment method as claimed in claim 1 further comprising a step of generating multiple fingerprint enrollment data according to the fingerprint images obtained by the fingerprint sensor.

12. An electronic device comprising:
a fingerprint sensor; and
a display showing an instruction when the electronic device proceeds a fingerprint enrollment, wherein the instruction is used to prompt a user to move a finger on the fingerprint sensor in a spiral path so that the fingerprint sensor obtains multiple fingerprint images.

13. The electronic device as claimed in claim 12, wherein the instruction comprises a spiral curve.

14. The electronic device as claimed in claim 12, wherein the instruction further comprises a direction symbol for indicating that a direction of the spiral curve is from an inside to an outside of the spiral curve or from the outside to the inside of the spiral curve to prompt the user to move the finger along with the direction.

15. The electronic device as claimed in claim 13, wherein a way to show the instruction is to show the spiral curve from an inside to an outside of the spiral curve or from the outside to the inside of the spiral curve.

16. The electronic device as claimed in claim 12, wherein the instruction comprises a text.

17. The electronic device as claimed in claim 12 further comprising a processing unit coupled to the fingerprint sensor and the display, wherein the processing unit provides the instruction to the display.

18. The electronic device as claimed in claim 17, wherein the processing unit further determines whether each of the fingerprint images is qualified.

19. The electronic device as claimed in claim 18, wherein the step for the processing unit to determine whether each of the fingerprint images is qualified comprises a step of:
determining whether a current fingerprint image is different from a previous fingerprint image obtained before the current fingerprint image.

20. The electronic device as claimed in claim 18, wherein the step for the processing unit to determine whether each of the fingerprint images is qualified comprises a step of:
determining whether a fingerprint density of a current fingerprint image falls within a tolerance range.

21. The electronic device as claimed in claim 18, wherein after the processing unit determining multiple qualified fingerprint images from the fingerprint images, the processing unit executes a step of stitching the qualified fingerprint images into a complete fingerprint image.

22. The electronic device as claimed in claim 17, wherein the processing unit generates multiple fingerprint enrollment data according to the fingerprint images.
